(19) United States
(12) Patent Application Publication
(10) Pub. No.: US 2024/0149156 A1
(43) Pub. Date: May 9, 2024

(54) COMPUTER-READABLE RECORDING MEDIUM, COMPUTER APPARATUS AND METHOD

(71) Applicant: Square Enix Co., Ltd., Tokyo (JP)

(72) Inventors: Shinpei SAKATA, Tokyo (JP); Yusuke MORI, Tokyo (JP)

(73) Assignee: Square Enix Co., Ltd., Tokyo (JP)

(21) Appl. No.: 18/503,095

(22) Filed: Nov. 6, 2023

(30) Foreign Application Priority Data
Nov. 7, 2022 (JP) 2022-178487

(51) Int. Cl. A63F 13/45; A63F 13/5375; G06F 40/279

(52) U.S. Cl. CPC A63F 13/45; A63F 13/5375; G06F 40/279

(57) ABSTRACT

An object is to provide a new program with a higher level of satisfaction while increasing a player's freedom for provided content.

An example content providing program determines whether or not information received from a user is similar to a predetermined character string corresponding to progress information and progresses the content in a case where it is determined that the information is similar to the predetermined character string.

### CROSS-REFERENCE TO RELATED APPLICATION(S)

The present disclosure claims priority to Japanese Patent Application No. 2022-178487, filed on Nov. 7, 2022, the disclosure of which is expressly incorporated herein by reference in its entirety for any purpose.

### BACKGROUND

The present disclosure relates to a computer-readable recording medium, a computer apparatus, and a method that provide content to a user.

In the related art, there are games such as adventure games in which a user interacts with a computer-controlled character. In the game, the user inputs text to a character corresponding to the user or selects an action from a plurality of options to progress content (hereinafter, also referred to as a story).

However, in the method in which the user inputs text, it is not possible to progress the story unless a character string that is exactly matched with a character string assumed by a programmer is received, and the level of satisfaction of the content is low. In addition, in the game in which only options are selected, it is not possible to reflect the user's inferences in the game, and the user is given the feeling of just following the story and is unable to fully enjoy the content.

### SUMMARY

An object of at least one embodiment of the present disclosure is to provide a new program with a higher level of satisfaction while increasing the player's freedom for provided content.

According to a non-limiting aspect, the present disclosure is to provide a non-transitory computer-readable recording medium having recorded thereon a program causing a computer apparatus to implement a function of providing content to a user, the program causing the computer apparatus to perform functions comprising, storing progress information which is information for the user to progress the content, storing progress control information used for progressing the content in association with the progress information and a predetermined character string, receiving an input of information from the user, determining whether or not the received information is similar to the predetermined character string corresponding to the progress information, progressing the content on the basis of the progress control information when it is determined that the received information is similar to the predetermined character string, and outputting answer data to the received information.

According to a non-limiting aspect, the present disclosure is to provide a computer apparatus for providing content to a user, the computer apparatus comprising, storing progress information which is information for the user to progress the content, storing progress control information used for progressing the content in association with the progress information and a predetermined character string, receiving an input of information from the user, determining whether or not the received information is similar to the predetermined character string corresponding to the progress information, progressing the content on the basis of the progress control information when it is determined that the received information is similar to the predetermined character string, and outputting answer data to the received information.

According to a non-limiting aspect, the present disclosure is to provide a method for providing content, the method comprising, receiving an input of information from a user, determining whether or not the received information is similar to a predetermined character string corresponding to progress information which is information for the user to progress the content, progressing the content on the basis of progress control information, which is used for progressing the content and is associated with the progress information and the predetermined character string when it is determined that the received information is similar to the predetermined character string, and outputting answer data to the received information. Each embodiment of the present disclosure addresses one or more deficiencies.

### BRIEF DESCRIPTION OF THE DRAWINGS

FIG. 1 is a block diagram illustrating a configuration of a computer apparatus corresponding to at least one embodiment of the present disclosure.

FIG. 2 is a diagram illustrating a progress information data table corresponding to at least one embodiment of the present disclosure.

FIG. 3 is a diagram illustrating a progress control master table corresponding to at least one embodiment of the present disclosure.

FIG. 4 is a flowchart illustrating a program execution process corresponding to at least one embodiment of the present disclosure.

FIG. 5 is a block diagram illustrating a configuration of a computer apparatus corresponding to at least one embodiment of the present disclosure.

FIG. 6 is a flowchart illustrating a program execution process corresponding to at least one embodiment of the present disclosure.

FIG. 7 is a block diagram illustrating a configuration of a computer apparatus corresponding to at least one embodiment of the present disclosure.

FIG. 8 is a flowchart illustrating a program execution process corresponding to at least one embodiment of the present disclosure.

### DESCRIPTION OF EMBODIMENTS

Hereinafter, embodiments of the present disclosure will be described with reference to the accompanying drawings. The following description related to the effects is one aspect of the effects of the embodiments of the present disclosure, and the effects are not limited to those described here. Further, the order of each process constituting flowcharts which will be described below is particularly limited as long as there is no contradiction or inconsistency in the content of the processes.

### First Embodiment

An outline of a first embodiment of the present disclosure will be described. As the first embodiment, an example of a program for causing a computer apparatus to implement a function of providing content to a user will be described below.

Outline of Program

In the first embodiment of the present disclosure, an adventure game is given as an example of the content to be provided, and a game program for the game is given as an example of the program.

For example, a stand-alone system configuration will be described. However, some of the functions, which will be described in detail below, may be transferred to a server device and implemented by a network system that performs communication between a terminal device and a server device.

For example, a game in which a user gives an operational instruction to a user character corresponding to the user to have a conversation with another character (hereinafter, also referred to as a non-player character (NPC)) in the game, thereby progressing a story is assumed as an example of the adventure game according to the first embodiment. However, the present disclosure is not limited to the adventure game. The present disclosure covers the scope to which those skilled in the art can apply the present disclosure.

Computer Apparatus

For example, a computer apparatus 1 includes a control unit, a memory device such as random-access memory (RAM), a storage unit, a sound processing unit, a graphics processing unit, a communication interface, and an interface unit, which are connected to one another by an internal bus. The graphics processing unit is connected to a display unit. The display unit may include a display screen and a touch input unit that receives an input by the contact of the user on the display unit.

It is preferable that the storage unit has a capacity capable of storing an engine related to natural language processing (NLP). Further, it is preferable that the control unit has specifications that allow execution of the natural language processing.

For example, the touch input unit may detect a contact position using any method, such as a resistive film method, a capacitive method, an ultrasonic surface acoustic wave method, an optical method, or an electromagnetic induction method, used for a touch panel, and any method may be used as long as it can recognize an operation performed by a touch operation of the user. The touch input unit is a device that can detect the position of a finger or the like in a case where the user performs an operation, such as pressing or movement, on an upper surface of the touch input unit with a finger, a stylus, or the like.

An external memory device, for example, a secure digital (SD) card, can be connected to the interface unit. Data read from the external memory device is loaded into the memory device in the computer apparatus 1, and the control unit performs a calculation process.

The communication interface can be connected to a communication network in a wireless or wired manner and can receive data through the communication network. Similarly to the data read from the external memory device, the data received through the communication interface is loaded into the memory device in the computer apparatus 1, and the control unit performs a calculation process.

The computer apparatus 1 may include a sensor such as a proximity sensor, an infrared sensor, a gyro sensor, or an acceleration sensor. Further, the computer apparatus 1 may include an imaging unit that has a lens and captures an image through the lens. Furthermore, the computer apparatus 1 may be a terminal device that can be mounted (wearable) on a human body.

Description of Functions

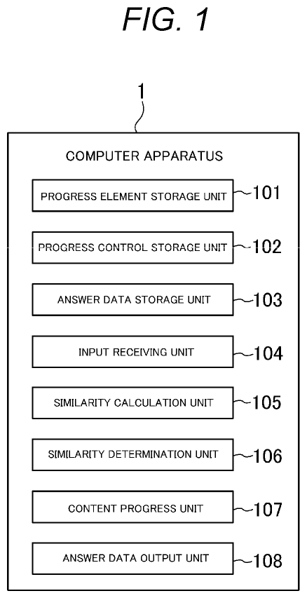

The functions of the computer apparatus 1 according to the first embodiment will be described. FIG. 1 is a block diagram illustrating a configuration of a computer apparatus corresponding to at least one embodiment of the present disclosure.

The computer apparatus 1 can include a progress information storage unit 101, a progress control storage unit 102, an answer data storage unit 103, an input receiving unit 104, a similarity calculation unit 105, a similarity determination unit 106, a content progress unit 107, and an answer data output unit 108.

The progress information storage unit 101 has a function of storing progress information which is information for the user to progress content. The progress control storage unit 102 has a function of storing progress control information used for progressing the content in association with the progress information and a predetermined character string.

The answer data storage unit 103 has a function of storing answer data in association with the progress information and the predetermined character string. The input receiving unit 104 has a function of receiving information input from the user.

The similarity calculation unit 105 has a function of calculating a similarity between the information received by the input receiving unit 104 and the predetermined character string corresponding to the progress information stored in the progress information storage unit 101. The similarity determination unit 106 has a function of determining whether or not the information received by the input receiving unit 104 is similar to the predetermined character string corresponding to the progress information.

The content progress unit 107 has a function of progressing the content on the basis of the progress control information in a case where the similarity determination unit 106 determines that the information is similar to the predetermined character string. The answer data output unit 108 has a function of outputting answer data to the information received by the input receiving unit 104.

The computer apparatus 1 may include, for example, a first answer acquisition unit and a second answer acquisition unit that acquire answers, which is not illustrated. Each of the functions is described in the flowcharts which will be described below.

Next, before the description of a content progress process in this embodiment, the progress information stored in the progress information storage unit 101 and the progress control information stored in the progress control storage unit 102 will be described.

Progress Information

The “progress information” refers to, for example, information indicating a history of the content and information that serves as a clue for progressing the content. Progress information can be information that increases or decreases during the progress of the content.

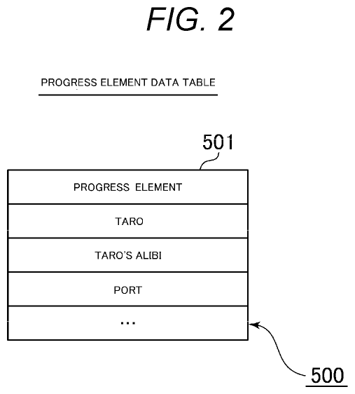

FIG. 2 is a diagram illustrating a progress information data table corresponding to at least one embodiment of the present disclosure. A progress information data table 500 can store progress information 501. The progress information is an element obtained while the content is progressing up to that time and includes, for example, “Taro” indicating the name of a character in the content, “Taro's alibi” which is one of information items of the content, and a “port” indicating a movable location. The number of progress information increases and decreases with the progress of the content. The progress information data table is data held for each user, and different data can be stored depending on a progress status.

Progress Control Information

The “progress control information” refers to, for example, information used for progressing the content. The progress control information is information necessary for the progress of the content and is information for normally progressing the content. Therefore, it is preferable that the progress control information is stored as master data.

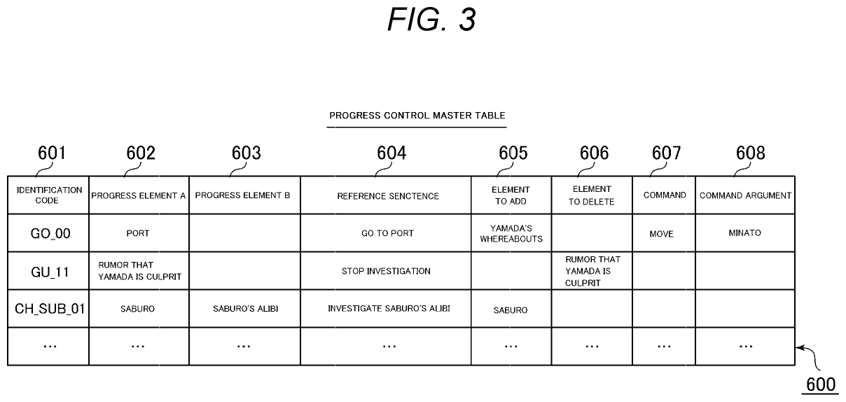

FIG. 3 is a diagram illustrating a progress control master table corresponding to at least one embodiment of the present disclosure. A progress control master table 600 can store progress information A 602, progress information B 603, a reference sentence 604, an element to add 605, an element to delete 606, a command 607, and a command argument 608 in association with an identification code 601.

The progress information A and B are items that correspond to the progress information 501 stored in the progress information data table 500. The reference sentence 604 is a value that is used in a similarity calculation process which will be described below. The element to add 605 and the element to delete 606 are items that will be added to and deleted from the progress information data table 500. The command 607 and the command argument 608 indicate the command and argument to be executed.

A table in which the progress information A and B are illustrated is given as an example of the progress control master table 600. However, the progress control master table 600 is not limited thereto. The progress control master table 600 can include one or more progress information. The same is applied to the element to add 605 and the element to delete 606, and the progress control master table 600 can include one or more elements to add 605 and one or more elements to delete 606. Here, the identification code 601 is used as a key item. However, the identification code 601 may not be used, and the progress information 602 and 603 and the reference sentence 604 may be used as key items.

Program Execution Process

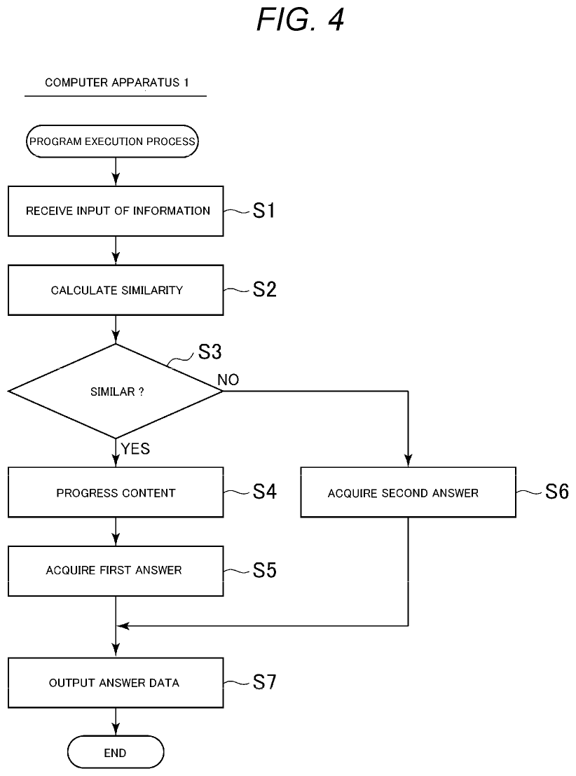

Next, a program execution process according to the first embodiment of the present disclosure will be described. FIG. 4 is a flowchart illustrating a program execution process corresponding to at least one embodiment of the present disclosure.

For convenience of explanation, it is assumed that the user progresses the content halfway and the data illustrated in FIG. 2 is stored in the progress information data table 500.

The computer apparatus 1 receives the input of information from the user (Step S1). The input of the information can include, for example, the input of text, the input of handwritten characters, voice input, and gesture input.

Then, the computer apparatus 1 calculates the similarity between the information received in Step S1 and a predetermined character string corresponding to the progress information stored in the progress information storage unit 101 (Step S2). Then, the computer apparatus 1 determines whether or not the received information is similar to the predetermined character string, using the similarity calculated in Step S2 (Step S3).

Calculation of Similarity and Determination of Similarity

First, the information input in Step S1 is converted into text data such that it can be treated as a sentence, if necessary. Then, the sentence of the input information and a sentence distributed representation of the reference sentence 604 are acquired. As a method for acquiring the sentence distributed representation, for example, a method, such as skip-thoughts or sentence-BERT, is used to perform conversion into a vector at a sentence level.

A cosine similarity can be used to calculate the similarity between the vectors. The cosine similarity is a measure of how similar two vectors are and specifically is a cosine value of an angle formed between two vectors in a vector space. The cosine similarity is normalized to a range of +1 to −1.

In a case where the cosine similarity is greater than a predetermined threshold value, it is determined that the two vectors are similar to each other. In a case where the cosine similarity is equal to or less than the predetermined threshold value, it is determined that the two vectors are dissimilar to each other. In a case where a plurality of items are greater than a predetermined threshold value, data having the reference sentence 604 for which a value closest to +1 has been calculated is specified.

The cosine similarity has been used in the above description. However, it may be designed to calculate a distance between the vectors using the cosine similarity. Further, other methods for calculating the similarity between the vectors may be used, and a method for calculating the similarity between the vectors at the sentence level may be used.

The description returns to FIG. 4. In a case where it is determined in Step S3 that the received information is similar to the predetermined character string (YES in Step S3), the computer apparatus 1 progresses the content on the basis of the progress control information (Step S4). The progress of the content based on the progress control information means, for example, updating the data in the progress information data table 500 on the basis of the element to add 605 and the element to delete 606 or executing the program using the command 607 and the command argument 608. The computer apparatus 1 can further include a progress information change unit in order to change the data in the progress information data table 500.

Then, the computer apparatus 1 acquires answer data (first answer) to the received information (Step S5). The computer apparatus 1 can store the answer data in the answer data storage unit 103 in association with the identification code 601 which is a key capable of uniquely specifying the data in the progress control master table 600 or with the progress information and the reference sentence, which is not illustrated. The computer apparatus 1 acquires an answer sentence corresponding to the identification code 601 of the data having the reference sentence determined to be similar.

The same data as the data stored in the answer data storage unit 103 is assumed as the answer data (first answer) described here. In other words, the answer data (first answer) is static data and is data that has been prepared in advance.

In a case where it is determined in Step S3 that the received information is not similar to the predetermined character string (NO in Step S3), the computer apparatus 1 acquires answer data (second answer) which is a predetermined fixed phrase (Step S6). The second answer may be, for example, a fixed phrase such as “I don't understand” or “Please enter again”. The second answer may not be acquired, and the fixed phrase may be fixed and displayed.

The computer apparatus 1 outputs the answer data acquired in Step S5 or Step S6 (Step S7), and ends the process. The program execution process according to the first embodiment is described in units of reception of the input of information from the user. However, in practice, the content may continue to be provided until the content is completed by repeatedly performing the process from the reception of the input in Step S1 to the output of the answer in Step S7.

The description will be supplemented with specific examples. In a case where the information input by the user in Step S1 is text information “Go to the port” and the progress information held by the user is the content illustrated in FIG. 2, the computer apparatus 1 specifies the data of the identification code 601 “GO_00” in which the “port” included in the progress information held by the user is matched with the “port” in the progress information A602 of the progress control master table 600. Then, in Step S2, the similarity between the reference sentence 604 of “Go to the port” and the received sentence “Go to the port” is calculated.

Assuming that these sentences are determined to be similar to each other, the computer apparatus 1 adds the element to add 605 of “Yamada's whereabouts” to the progress information data table 500 and executes the command 607 of “move” and the command argument 608 of “MINATO” (the content progress process in Step S4). When the command 607 and the command argument 608 are executed, for example, the scene changes to the port.

Then, the computer apparatus 1 acquires an answer sentence corresponding to the reference sentence 604 of “Go to the port” stored in the answer data storage unit 103. A sentence “I came to the port” can be stored as an example of the answer sentence. Here, the answer data “I came to the port” is acquired. Then, the computer apparatus 1 outputs the acquired answer data and ends the process. The answer data may be a sentence subjected to a process of, for example, adding a predetermined sentence to the acquired answer data such as “Mr. OO (the name specified by the user) came to the port”.

In the first embodiment, a method for acquiring the answer data has been described. However, the present disclosure is not limited thereto. For example, the computer apparatus 1 may store the answer data and select the answer data on the basis of a model subjected to machine learning.

As an aspect of the first embodiment, it is possible to provide a new program with a higher level of satisfaction while increasing the player's freedom for the provided content.

As an aspect of the first embodiment, the design is made such that the input from the user is received, information similar to the sentence assumed by a developer is input, and the content progress process is performed for the first time. Therefore, it is possible to provide a program that allows the user to think about what to input and can further convey the appeal of the content while increasing the user's freedom.

In the first embodiment, for example, the “computer apparatus” refers to a stationary game console, a portable game console, a wearable terminal, a desktop or laptop personal computer, a tablet computer, or a PDA and may be a portable terminal such as a smartphone including a touch panel sensor on a display screen. The “progress information” refers to, for example, information indicating the history of the content and information that serves as a clue for progressing the content. The progress information may be a tag, a division, and the like. The “predetermined character string” refers to, for example, a sentence that is one of the elements for progressing the content and is a sentence used for similarity determination. The “progress control information” refers to, for example, conditions and commands for progressing the content.

### Second Embodiment

An outline of a second embodiment of the present disclosure will be described. Hereinafter, as a second embodiment, a program for causing a computer apparatus to implement a function of providing content to a user will be described as an example.

Outline of Program

In the second embodiment of the present disclosure, an adventure game is given as an example of the content to be provided, and a game program for the game is given as an example of the program.

For example, a stand-alone system configuration will be described. However, some of the functions, which will be described in detail below, may be transferred to a server device and implemented by a network system that performs communication between a terminal device and a server device.

A game in which the user gives an operational instruction to a user character corresponding to the user to have a conversation with an NPC in the game, thereby progressing a story is assumed as an example of the adventure game according to the second embodiment. However, the present disclosure is not limited to the adventure game. The present disclosure covers the scope to which those skilled in the art can apply the present disclosure.

A necessary range of the configuration of the computer apparatus 1 according to the first embodiment can be adopted as a configuration of a computer apparatus 1 according to the second embodiment.

Description of Functions

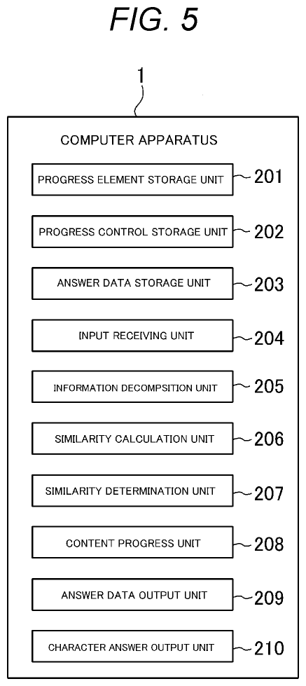

The functions included in the computer apparatus 1 according to the second embodiment will be described. FIG. 5 is a block diagram illustrating a configuration of a computer apparatus corresponding to at least one embodiment of the present disclosure.

The computer apparatus 1 includes a progress information storage unit 201, a progress control storage unit 202, an answer data storage unit 203, an input receiving unit 204, an information decomposition unit 205, a similarity calculation unit 206, a similarity determination unit 207, a content progress unit 208, an answer data output unit 209, and a character answer data output unit 210.

The progress information storage unit 201 has a function of storing progress information which is information for the user to progress the content. The progress control storage unit 202 has a function of storing progress control information used for progressing the content in association with the progress information and a predetermined character string.

The answer data storage unit 203 has a function of storing answer data in association with the progress information and the predetermined character string. The input receiving unit 204 has a function of receiving the input of information from the user.

The information decomposition unit 205 has a function of decomposing the information received by the input receiving unit 204 into key points for understanding the content of the information. The similarity calculation unit 206 has a function of calculating a similarity between the information received by the input receiving unit 204 and the predetermined character string corresponding to the progress information stored in the progress information storage unit 201. The similarity determination unit 207 has a function of determining whether or not the information received by the input receiving unit 204 is similar to the predetermined character string corresponding to the progress information.

The content progress unit 208 has a function of progressing the content on the basis of the progress control information in a case where the similarity determination unit 207 determines that the information is similar to the predetermined character string. The answer data output unit 209 has a function of generating answer data using a natural language generation model on the basis of the key points acquired by the information decomposition unit 205 and outputting the answer data.

The character answer data output unit 210 has a function of generating answer data on the basis of the answer data output by the answer data output unit 209 using a natural language generation model corresponding to attributes of the character included in the content and outputting the answer data.

The computer apparatus 1 may include, for example, a first answer acquisition unit that acquires an answer and a second answer generation unit, which is not illustrated. Each of the functions is described in the flowcharts which will be described below.

Necessary ranges of the description of the progress information stored in the progress information storage unit 101, the description of the progress control information stored in the progress control storage unit 102, and the content illustrated in FIGS. 2 and 3 in the first embodiment can be adopted as the progress information stored in the progress information storage unit 201 and the progress control information stored in the progress control storage unit 202 in the second embodiment.

Program Execution Process

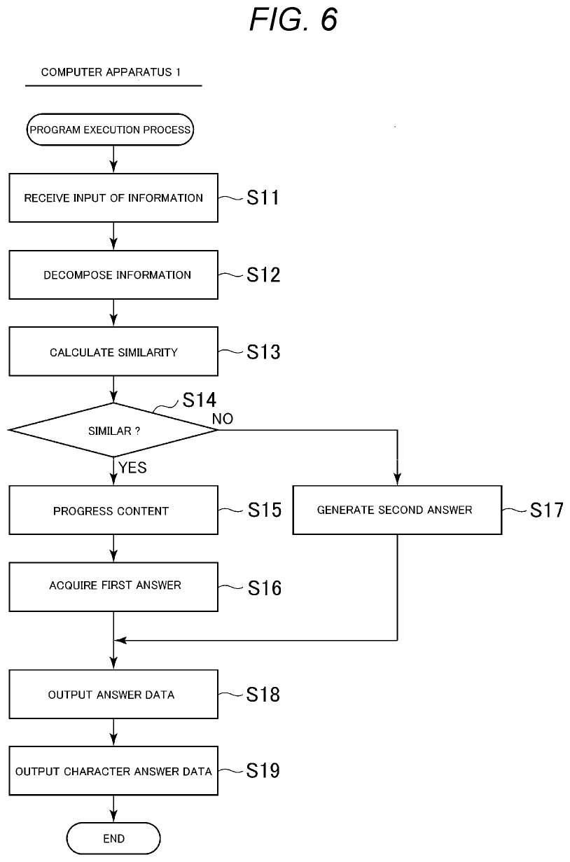

Next, a program execution process according to the second embodiment of the present disclosure will be described. FIG. 6 is a flowchart illustrating a program execution process corresponding to at least one embodiment of the present disclosure.

For convenience of explanation, it is assumed that the user progresses the content halfway and the data illustrated in FIG. 2 is stored in the progress information data table 500.

The computer apparatus 1 receives the input of information from the user (Step S11). The input of the information can include, for example, the input of text, the input of handwritten characters, voice input, and gesture input.

Then, the computer apparatus 1 decomposes the information received in Step S11 into key points for understanding the content of the information (Step S12). The key points can be used for similarity determination and for generating a second answer, which will be described below.

Then, the computer apparatus 1 calculates the similarity between the information received in Step S11 and a predetermined character string corresponding to the progress information stored in the progress information storage unit 201 (Step S13). Then, the computer apparatus 1 determines whether or not the received information is similar to the predetermined character string (for example, the reference sentence 604 illustrated in FIG. 3), using the similarity calculated in Step S13 (Step S14). A necessary range of the content described in the calculation of the similarity and the determination of the similarity in the first embodiment can be adopted as the calculation of the similarity and the determination of the similarity.

In a case where it is determined in Step S14 that the received information is similar to the predetermined character string (YES in Step S14), the computer apparatus 1 progresses the content on the basis of the progress control information (Step S15). The progress of the content based on the progress control information means, for example, updating the data in the progress information data table 500 on the basis of the element to add 605 and the element to delete 606 or executing the program using the command 607 and the command argument 608 illustrated in FIG. 3.

Then, the computer apparatus 1 acquires answer data (first answer) to the received information (Step S16). The computer apparatus 1 can store the answer data in the answer data storage unit 203 in association with the identification code 601 which is a key capable of uniquely specifying the data in the progress control master table 600 or with the progress information and the reference sentence, which is not illustrated. The computer apparatus 1 acquires an answer sentence corresponding to the identification code 601 of the data having the reference sentence determined to be similar.

Here, the same data as the data stored in the answer data storage unit 203 is assumed as the answer data (first answer). In other words, the answer data (first answer) is static data and is data that has been prepared in advance.

In a case where it is determined in Step S14 that the received information is not similar to the predetermined character string (NO in Step S14), the computer apparatus 1 generates answer data (second answer) on the basis of key point data acquired by the decomposition in Step S12, using the natural language generation model (Step S17).

For example, in a case where the input data is “I'm thirsty”, the computer apparatus 1 generates an answer sentence “Let's buy a drink” as the second answer, using an engine of the natural language generation model. Since the input data is not similar to the reference sentence 604, the content of the second answer often has little relation to the progress of the content.

Then, the computer apparatus 1 outputs the answer data acquired in Step S16 or the answer data generated in Step S17 (Step S18). Then, the computer apparatus 1 generates answer data on the basis of the answer data output in Step S18, using a natural language generation model corresponding to the attributes of the character included in the content and outputs the answer data (Step S19). Then, the computer apparatus 1 ends the process.

Output of Character Answer

A character learning model considering the attributes (for example, personality, emotion, and individuality) of the character is prepared in order to implement a character answer output function. The description of a method for creating the learning model will be omitted since the method has little relation to the content of the present disclosure.

In a case where the answer data output in Step S18 is “Who do you arrest?”, when the answer data is input to the character learning model, for example, answer data “Who do you want to arrest?” is output. In other words, it is possible to obtain answers as if the character was speaking, to enjoy more natural conversation, and to further improve user satisfaction.

The program execution process according to the second embodiment is described in units of reception of the input of information from the user. However, in practice, the content may continue to be provided until the content is completed by repeatedly performing the process from the reception of the input in Step S11 to the output of the character answer in Step S19.

In the second embodiment, a method for acquiring the answer data has been described. However, the present disclosure is not limited thereto. For example, the computer apparatus 1 may store the answer data and select the answer data on the basis of a model subjected to machine learning.

In the second embodiment, the second answer is generated using the engine of the natural language generation model. However, the present disclosure is not limited thereto. For example, the second answer may be generated by combining an engine of a natural language understanding model and the engine of the natural language generation model.

As an aspect of the second embodiment, it is possible to provide a new program with a higher level of satisfaction while increasing the player's freedom for the provided content.

As an aspect of the second embodiment, the design is made such that the input from the user is received, information similar to the sentence assumed by the developer is input, and the content progress process is performed for the first time. Therefore, it is possible to provide a program that allows the user to think about what to input and can further convey the appeal of the content while increasing the user's freedom.

As an aspect of the second embodiment, in a case where the information input from the user is not similar to the sentence assumed by the developer, an answer is output using the natural language processing. Therefore, it is possible to give the user an immersive feeling as if the user is actually participating in the content and thus to further increase the level of satisfaction while increasing the user's freedom.

In the second embodiment, a necessary range of the content described in the first embodiment can be adopted as each of the “computer apparatus”, the “progress information”, the “predetermined character string”, and the “progress control information”.

In the second embodiment, the “key points” refer to, for example, elements used to understand the content of the information input by the user and can also be referred to as keywords. More specifically, the key points may be morphemes obtained by morphologically analyzing the text of the input information or a group of sentences after syntactic analysis. The “generation” refers to, for example, inferring unknown data from given data.

### Third Embodiment

An outline of a third embodiment of the present disclosure will be described. Hereinafter, as the third embodiment, a program for causing a computer apparatus to implement a function of providing content to a user will be described as an example.

Outline of Program

In the third embodiment of the present disclosure, an adventure game is given as an example of the content to be provided, and a game program for the game is given as an example of the program.

For example, a stand-alone system configuration will be described. However, some of the functions, which will be described in detail below, may be transferred to a server device and implemented by a network system that performs communication between a terminal device and a server device.

A game in which the user gives an operational instruction to a user character corresponding to the user to have a conversation with an NPC in the game, thereby progressing a story is assumed as an example of the adventure game according to the third embodiment. However, the present disclosure is not limited to the adventure game. The present disclosure covers the scope to which those skilled in the art can apply the present disclosure.

A necessary range of the configuration of the computer apparatus 1 according to the first embodiment can be adopted as a configuration of a computer apparatus 1 according to the third embodiment.

Description of Functions

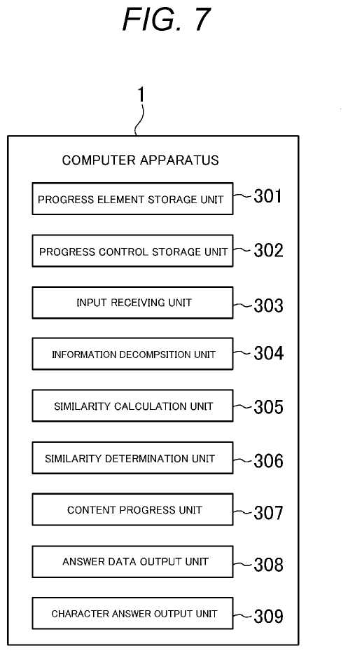

The functions included in the computer apparatus 1 according to the third embodiment will be described. FIG. 7 is a block diagram illustrating a configuration of a computer apparatus corresponding to at least one embodiment of the present disclosure.

The computer apparatus 1 can include a progress information storage unit 301, a progress control storage unit 302, an input receiving unit 303, an information decomposition unit 304, a similarity calculation unit 305, a similarity determination unit 306, a content progress unit 307, an answer data output unit 308, and a character answer data output unit 309.

The progress information storage unit 301 has a function of storing progress information which is information for the user to progress the content. The progress control storage unit 302 has a function of storing progress control information used for progressing the content in association with the progress information and a predetermined character string.

The input receiving unit 303 has a function of receiving the input of information from the user. The information decomposition unit 304 has a function of decomposing the information received by the input receiving unit 303 into key points for understanding the content of the information.

The similarity calculation unit 305 has a function of calculating a similarity between the information received by the input receiving unit 303 and the predetermined character string corresponding to the progress information stored in the progress information storage unit 301. The similarity determination unit 306 has a function of determining whether or not the information received by the input receiving unit 303 is similar to the predetermined character string corresponding to the progress information.

The content progress unit 307 has a function of progressing the content on the basis of the progress control information in a case where the similarity determination unit 306 determines that the information is similar to the predetermined character string. The answer data output unit 308 has a function of generating answer data using the natural language generation model on the basis of the key points acquired by the information decomposition unit 304 and outputting the answer data. The character answer data output unit 309 has a function of generating answer data on the basis of the answer data output by the answer data output unit 308 using a natural language generation model corresponding to the attributes of the character included in the content and outputting the answer data.

Necessary ranges of the description of the progress information stored in the progress information storage unit 101, the description of the progress control information stored in the progress control storage unit 102, and the content illustrated in FIGS. 2 and 3 in the first embodiment can be adopted as the progress information stored in the progress information storage unit 301 and the progress control information stored in the progress control storage unit 302 in the third embodiment.

The computer apparatus 1 may include, for example, a first answer generation unit and a second answer generation unit that generate answers, which is not illustrated. Each of the functions is described in the flowcharts which will be described below.

Program Execution Process

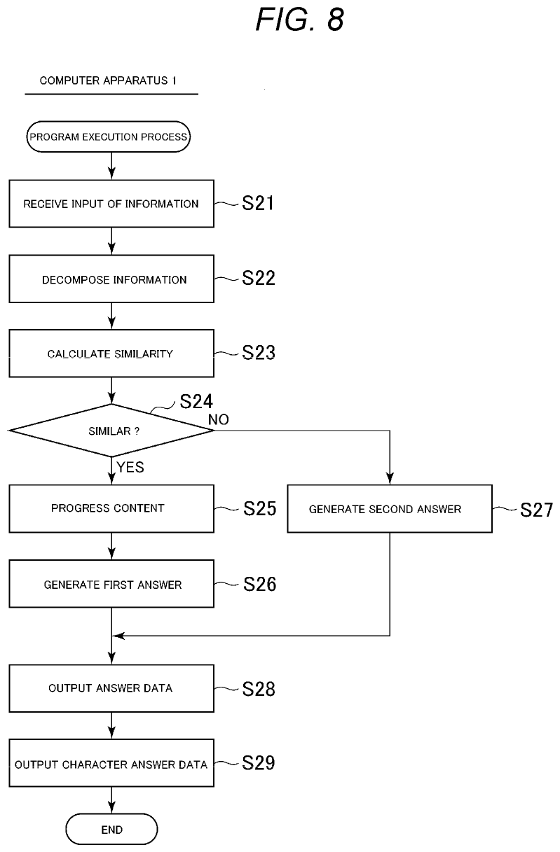

Next, a program execution process according to the third embodiment of the present disclosure will be described. FIG. 8 is a flowchart illustrating a program execution process corresponding to at least one embodiment of the present disclosure.

For convenience of explanation, it is assumed that the user progresses the content halfway and the data illustrated in FIG. 2 is stored in the progress information data table 500.

The computer apparatus 1 receives the input of information from the user (Step S21). The input of the information can include, for example, the input of text, the input of handwritten characters, voice input, and gesture input.

Then, the computer apparatus 1 decomposes the information received in Step S21 into key points for understanding the content of the information (Step S22). The key points can be used for similarity determination and for generating a first answer and a second answer, which will be described below.

Then, the computer apparatus 1 calculates the similarity between the information received in Step S21 and a predetermined character string corresponding to the progress information stored in the progress information storage unit 301 (Step S23). Then, the computer apparatus 1 determines whether or not the received information is similar to the predetermined character string, using the similarity calculated in Step S23 (Step S24). A necessary range of the content described in the calculation of the similarity and the determination of the similarity in the first embodiment can be adopted as the calculation of the similarity and the determination of the similarity.

In a case where it is determined in Step S24 that the received information is similar to the predetermined character string (YES in Step S24), the computer apparatus 1 progresses the content on the basis of the progress control information (Step S25). The progress of the content based on the progress control information means, for example, updating the data in the progress information data table 500 on the basis of the element to add 605 and the element to delete 606 or executing the program using the command 607 and the command argument 608 illustrated in FIG. 3.

Then, the computer apparatus 1 generates answer data (first answer) to the received information (Step S26). That is, the computer apparatus 1 generates answer data (first answer) on the basis of key point data acquired by the decomposition in Step S22 and the predetermined character string (for example, the reference sentence 604 illustrated in FIG. 3), using the natural language generation model.

For example, in a case in which the input data is “Let's go to Kyoto” and it is determined in Step S24 that the received information is similar to the predetermined character string, the computer apparatus 1 generates, as the first answer, for example, an answer sentence “Yes, let's hurry” using the engine of the natural language generation model. Since the input data is similar to the reference sentence 604, the content of the first answer is often related to the progress of the content.

In a case in which it is determined in Step S24 that the received information is not similar to the predetermined character string (NO in Step S24), the computer apparatus 1 generates answer data (second answer) on the basis of the key point data acquired by the decomposition in Step S22, using the natural language generation model (Step S27).

In a case where the input data is “I'm thirsty” and, for example, it is determined in Step S24 that the received information is not similar to the predetermined character string, the computer apparatus 1 generates, as the second answer, for example, an answer sentence “Let's buy a drink”, using the engine of the natural language generation model. Since the input data is not similar to the reference sentence 604, the content of the second answer often has little relation to the progress of the content.

The first answer requires the inclusion of a specific meaning in the content, and a task-oriented dialogue is performed. The second answer does not require the inclusion of a specific meaning in the content, and a non-task-oriented dialogue (also referred to as a small talk) is performed. In both cases, answers are generated, but the roles of the answers in the content are different.

Then, the computer apparatus 1 outputs the first answer data generated in Step S26 or the second answer data generated in Step S27 (Step S28). Then, the computer apparatus 1 generates answer data on the basis of the answer data output in Step S28, using a natural language generation model corresponding to the attributes of the character included in the content, and outputs the answer data (Step S29). Then, the computer apparatus 1 ends the process. A necessary range of the content described in the output of the character answer in the second embodiment can be adopted as the output of the character answer.

The program execution process according to the third embodiment is described in units of reception of the input of information from the user. However, in practice, the content may continue to be provided until the content is completed by repeatedly performing the process from the reception of the input in Step S21 to the output of the character answer in Step S28.

In the third embodiment, the first answer and the second answer are generated using the engine of the natural language generation model. However, the present disclosure is not limited thereto. For example, the first answer and the second answer may be generated by combining the engine of the natural language understanding model and the engine of the natural language generation model.

As an aspect of the third embodiment, it is possible to provide a new program with a higher level of satisfaction while increasing the player's freedom for the content to be provided.

As an aspect of the third embodiment, the design is made such that the input from the user is received, information similar to the sentence assumed by the developer is input, and the content progress process is performed for the first time. Therefore, it is possible to provide a program that allows the user to think about what to input and can further convey the appeal of the content while increasing the user's freedom.

As an aspect of the third embodiment, an answer is output using the natural language processing, which makes it possible to give the user an immersive feeling as if the user is actually participating in the content and thus to further increase the level of satisfaction while increasing the user's freedom.

In the third embodiment, a necessary range of the content described in the first embodiment can be adopted as each of the “computer apparatus”, the “progress information”, the “predetermined character string”, and the “progress control information”. A necessary range of the content described in the second embodiment can be adopted as each of the “key points” and the “generation”.

In some embodiments of the present disclosure, the input information is compared with the reference sentence 604 in the progress control master table 600 to determine the similarity. However, for example, each of the input information and the reference sentence may be decomposed into key points, and the key points may be compared to determine the similarity.

In the present disclosure, in a case where it is determined a predetermined number of times or more that the input information is not similar to the reference sentence 604, the answer data output unit may output hint information.

In the present disclosure, the computer apparatus 1 has all of the functions. However, the present disclosure is not limited thereto. For example, an engine related to the natural language processing may be disposed in an external server such that content can be provided in an environment connected by communication.

Those skilled in the art can recombine the contents described in each of the above-described embodiments to make an appropriate design.

Supplementary Notes

The embodiments have been described in such a manner that the following disclosure can be carried out by a person having ordinary skill in the art to which the disclosure pertains.

(1) A program causing a computer apparatus to implement a function of providing content to a user, the program causing the computer apparatus to function as:
progress information storage means for storing a progress information which is information for the user to progress the content;
progress control storage means for storing progress control information used for progressing the content in association with the progress information and a predetermined character string;
input receiving means for receiving an input of information from the user;
similarity determination means for determining whether or not the received information is similar to the predetermined character string corresponding to the progress information;
content progress means for progressing the content on the basis of the progress control information in a case where it is determined that the received information is similar to the predetermined character string; and
answer data output means for outputting answer data to the received information.

(2) The program according to (1), further causing the computer apparatus to function as:
answer data storage means for storing answer data in association with the progress information and the predetermined character string,
in which, in a case where the similarity determination means determines that the received information is similar to the predetermined character string, the answer data output means outputs the answer data on the basis of the answer data stored in the answer data storage means.

(3) The program according to (1), further causing the computer apparatus to function as:
information decomposition means for decomposing the information received by the input receiving means into key points for understanding content of the information,
in which, in a case where the similarity determination means determines that the received information is similar to the predetermined character string, the answer data output means generates the answer data on the basis of the key points and the predetermined character string stored in the progress control storage means, using a natural language generation model.

(4) The program according to (1) or (2), further causing the computer apparatus to function as:
information decomposition means for decomposing the information received by the input receiving means into key points for understanding content of the information,
in which, in a case where the similarity determination means determines that the received information is not similar to the predetermined character string, the answer data output means generates answer data on the basis of the key points, using a natural language generation model, and outputs the answer data.

(5) The program according to any one of (1) to (3),
in which the content progress means includes progress information change means for changing the progress information stored in the progress information storage means.

(6) The program according to any one of (1) to (3), further causing the computer apparatus to function as:
hint output means for outputting information which is a clue for content progress in a case where the information received by the input receiving means satisfies a predetermined condition.

(7) The program according to any one of (1) to (3), further causing the computer apparatus to function as:
character answer data output means for generating answer data on the basis of the answer data output by the answer data output means, using a natural language generation model corresponding to attributes of a character included in the content, and outputting the answer data.

(8) A computer apparatus for providing content to a user, the computer apparatus including:
progress information storage means for storing progress information which is information for the user to progress the content;
progress control storage means for storing progress control information used for progressing the content in association with the progress information and a predetermined character string;
input receiving means for receiving an input of information from the user;
similarity determination means for determining whether or not the received information is similar to the predetermined character string corresponding to the progress information;
content progress means for progressing the content on the basis of the progress control information in a case where it is determined that the received information is similar to the predetermined character string; and
answer data output means for outputting answer data to the received information.

(9) A method for providing content, the method including:
a step of receiving an input of information from a user;
a step of determining whether or not the received information is similar to a predetermined character string corresponding to progress information which is information for the user to progress the content;
a step of progressing the content on the basis of progress control information, which is used for progressing the content and is associated with the progress information and the predetermined character string, in a case where it is determined that the received information is similar to the predetermined character string; and
a step of outputting answer data to the received information.

(10) A program causing a server device to implement a content providing function in a system that includes a terminal device and the server device and provides content, the program causing the server device to function as:
progress information storage means for storing progress information which is information for the user to progress the content;
progress control storage means for storing progress control information used for progressing the content in association with the progress information and a predetermined character string;
input receiving means for receiving an input of information from the user;
similarity determination means for determining whether or not the received information is similar to the predetermined character string corresponding to the progress information;
content progress means for progressing the content on the basis of the progress control information in a case where it is determined that the received information is similar to the predetermined character string; and
answer data output means for outputting answer data to the received information.

(11) A server device in which the program according to (10) is installed.

(12) A system that includes a terminal device and a server device and provides content, the system including:
progress information storage means for storing progress information which is information for the user to progress the content;
progress control storage means for storing progress control information used for progressing the content in association with the progress information and a predetermined character string;
input receiving means for receiving an input of information from the user;
similarity determination means for determining whether or not the received information is similar to the predetermined character string corresponding to the progress information;
content progress means for progressing the content on the basis of the progress control information in a case where it is determined that the received information is similar to the predetermined character string; and
answer data output means for outputting answer data to the received information.

(13) A program causing a terminal device to implement a content providing function in a system that includes the terminal device and a server device and provides content, the program causing the terminal device to function as:
progress information storage means for storing progress information which is information for the user to progress the content;
progress control storage means for storing progress control information used for progressing the content in association with the progress information and a predetermined character string;
input receiving means for receiving an input of information from the user;
similarity determination means for determining whether or not the received information is similar to the predetermined character string corresponding to the progress information;
content progress means for progressing the content on the basis of the progress control information in a case where it is determined that the received information is similar to the predetermined character string; and
answer data output means for outputting answer data to the received information.

(14) A terminal device in which the program according to (13) is installed.

(15) A method for providing content in a server device in a system that includes a terminal device and the server device and provides content, the method including:
a step of receiving an input of information from a user;
a step of determining whether or not the received information is similar to a predetermined character string corresponding to progress information which is information for the user to progress the content;
a step of progressing the content on the basis of progress control information, which is used for progressing the content and is associated with the progress information and the predetermined character string, in a case where it is determined that the received information is similar to the predetermined character string; and
a step of outputting answer data to the received information.

(16) A method for providing content in a terminal device in a system that includes the terminal device and a server device and provides content, the method including:
a step of receiving an input of information from a user;
a step of determining whether or not the received information is similar to a predetermined character string corresponding to progress information which is information for the user to progress the content;
a step of progressing the content on the basis of progress control information, which is used for progressing the content and is associated with the progress information and the predetermined character string, in a case where it is determined that the received information is similar to the predetermined character string; and
a step of outputting answer data to the received information.

What is claimed is:

1. A non-transitory computer-readable recording medium having recorded thereon a program causing a computer apparatus to implement a function of providing content to a user, the program causing the computer apparatus to perform functions comprising:
storing progress information in the computer apparatus, the progress information comprising information for the user to progress the content;
storing progress control information in association with the progress information and a predetermined character string;
receiving an entry of information by the user;
determining whether the received information is similar to the predetermined character string;
progressing the content based on the progress control information when it is determined that the received information is similar to the predetermined character string; and
outputting answer data responsive to the received information.

2. The non-transitory computer-readable recording medium having recorded thereon the program according to claim 1, wherein the answer data is first answer data, the functions further comprising:
storing second answer data in association with the progress information and the predetermined character string in the computer apparatus; and
outputting the first answer data based on the second answer data, when it is determined that the received information is similar to the predetermined character string.

3. The non-transitory computer-readable recording medium having recorded thereon the program according to claim 1, the functions further comprising:
decomposing the received information into key points for understanding content of the information; and
generating the answer data based on the key points and the predetermined character string using a natural language generation model when it is determined that the received information is similar to the predetermined character string.

4. The non-transitory computer-readable recording medium having recorded thereon the program according to claim 1, the functions further comprising:
decomposing the received information into key points for understanding content of the information;
generating answer data based on the key points using a natural language generation model when it is determined that the received information is not similar to the predetermined character string; and
outputting the answer data.

5. The non-transitory computer-readable recording medium having recorded thereon the program according to claim 1, the functions further comprising:
changing the progress information stored in the computer apparatus.

6. The non-transitory computer-readable recording medium having recorded thereon the program according to claim 1, the functions further comprising:
outputting hint information including a clue for content progress,
wherein the received information satisfies a predetermined condition.

7. The non-transitory computer-readable recording medium having recorded thereon the program according to claim 1, wherein the answer data is first answer data, the functions further comprising:
generating second answer data based on said outputting the first answer data using a natural language generation model corresponding to attributes of a character included in the content; and
outputting the second answer data.

8. A computer apparatus for providing content to a user, the computer apparatus comprising:
a storage device configured to store data;
a controller configured to:
control the storage device to store progress information which is information for the user to progress the content; and
control the storage device to store progress control information in association with the progress information and a predetermined character string;
receive an entry of information by the user;
determine whether the received information is similar to the predetermined character string corresponding to the progress information;
progress the content based on the progress control information when it is determined that the received information is similar to the predetermined character string; and
output answer data responsive to the received information.

9. A method for providing content, the method comprising:
receiving an entry of information by a user;
determining whether the received information is similar to a predetermined character string corresponding to progress information which is information for the user to progress the content;
progressing the content based on the progress control information associated with the progress information and the predetermined character string when it is determined that the received information is similar to the predetermined character string; and
outputting answer data responsive to the received information.
